(19) United States
(12) Patent Application Publication
(10) Pub. No.: US 2024/0213785 A1
(43) Pub. Date: Jun. 27, 2024

(54) METHOD FOR GENERATING AN AC VOLTAGE, CIRCUIT ASSEMBLY AND POWER SUPPLY SYSTEM

(71) Applicant: SAX Power GmbH, Erbach (DE)

(72) Inventor: Anya XIE, Ulm (DE)

(21) Appl. No.: 18/389,863

(22) Filed: Dec. 20, 2023

(30) Foreign Application Priority Data
Dec. 21, 2022 (EP) 22 215 592.1

(51) Int. Cl. H02J 7/00

(52) U.S. Cl. CPC H02J 7/0014; H02J 7/007194

(57) ABSTRACT

A method for generating an alternating voltage (u₁) by interconnecting a plurality of DC voltage sources (4), comprises at least the following method steps:
detecting charge differences of the DC voltage sources (4);
taking the detected charge differences into account during the interconnection of the DC voltage sources (4) to carry out a charge balancing;
detecting temperature differences (□T) between the DC voltage sources (4); and
taking the detected temperature differences (□T) into account during the interconnection of the DC voltage sources (4) to carry out a temperature equalization.

### CROSS-REFERENCE TO RELATED APPLICATION

This application claims priority to European Patent Application No. 22 215 592.1 filed on Dec. 21, 2022, the entire disclosure of which is incorporated herein by reference in its entirety.

### FIELD OF THE DISCLOSURE

The invention relates to a method for generating an alternating voltage by interconnection of a plurality of DC voltage sources, according to the preamble of claim 1. The invention additionally relates to a computer program for carrying out the method.

The invention also relates to a circuit assembly for generating an AC voltage from a plurality of DC voltage sources, comprising at least one inverter unit for generating and providing the AC voltage, and a charge balancing unit for detecting and balancing charge differences between the DC voltage sources, according to the preamble of claim 11.

The invention further relates to a power supply system, comprising a circuit assembly for generating an alternating voltage and a plurality of DC voltage sources.

### BACKGROUND OF THE INVENTION

In power supply systems, battery storage systems are sometimes used, such as photovoltaic home storage systems (“solar batteries”) for storing surplus yield from photovoltaic systems, or drive batteries (“high-voltage storage”) for supplying the electric motors or power units of electric vehicles. These battery storage systems sometimes require battery voltages of several hundred volts. However, since the cell voltage of a single battery cell is only a few volts (e.g. 3.7 V for a lithium-ion battery), many individual battery cells must be connected in series to form a battery pack (hereafter also referred to as a “battery”).

Due to manufacturing factors, each battery cell of a battery exhibits differences in its properties, such as the cell capacity, self-discharge rate and temperature characteristics. Over time, these differences are further exacerbated by ageing effects. As a result, some battery cells will have not yet reached their maximum charge level during charging, while other battery cells will be already fully charged. Overcharging the already fully charged battery cells can eventually result in damage to them and even destroy them. To prevent this, the charging process must be terminated prematurely.

The discharging process behaves in a similar way. While some battery cells are already completely discharged, other battery cells sometimes still have enough stored energy to continue to drive an electric vehicle, for example. In the case of the electric vehicle, the driving operation would have to be terminated prematurely, as otherwise the weaker battery cells would be deeply discharged, which—as in the case of overcharging—can cause their destruction.

To ensure a smooth charging and discharging process, battery management systems (“BMS”) are used to balance the charge between the individual battery cells, see J. Qi, D. Lu., “Review of Battery Cell Balancing Techniques”, Australasian Universities Power Engineering Conference, AUPEC 2014, Curtin University, Perth, Australia, 28 Sep. 1 Oct. 2014.

The most common method at the time of filing is so-called passive charge balancing. In this case, already fully charged battery cells are discharged via a resistor, while the other battery cells are charged further. An obvious disadvantage of this method is that valuable electrical energy is lost and that the method does not provide a solution for the discharge process either.

The problems with passive charge balancing can be resolved by means of active charge balancing. However, this technology requires complex circuits with power-electronic components and complicated control. For inductive equalization circuits for example, two metal oxide semiconductor field-effect transistors (MOSFET) per battery cell may be required; for capacitive balancing circuits, even four may typically be required. Chokes, transformers or capacitors are also required as energy storage devices.

For generating three-phase voltages, e.g. for the electrical machines or electric motors in an electric vehicle, self-commutated inverters are often used. Typically, such an inverter consists of six power-electronic valves that are interconnected to form a three-phase bridge. In this “two-point inverter”, the sinusoidal alternating voltages are generated from pulsed voltages with three voltage levels (0, #U_{DC}). The level of the voltage pulses depends on the battery voltage U_{DC} and is therefore constant. To generate alternating voltages, the duration of the voltage pulses can be varied as an actuating element. It is usually calculated using the pulse width modulation (PWM) method. In this case, however, high interference voltages are found in the alternating voltages in the superimposed frequencies. In order to reduce the harmonics of the voltage, it is known to increase the clock frequencies of the inverter. As a rule, the clock frequencies of a modern converter are in the range from several kHz up to 100 kHz. However, the switching losses of the inverters increase in proportion to their clock frequency.

To avoid these problems, a modular inverter can be used, as proposed in DE 10 2011 004 248 A1, for example. In this technique, the individual battery cells are not connected in series directly, but via power-electronic H-bridge circuits. In this way, the number of voltage levels can be increased and the clock frequencies and thus the switching losses of the inverter can be reduced for a predetermined voltage quality. The level of the lowest voltage level is equal to the cell voltage of the battery used (e.g. 3.7 V).

The principle can be suitable for single-phase loads, and even for three-phase loads. For example, a three-phase modular inverter can be formed from two single-phase modular inverters connected in series, as proposed in the generic solution in DE 10 2018 003 642 A1.

Since the individual battery cells can each be switched via a separate H-bridge, charge balancing of the battery cells is possible. If individual battery cells fail, the inverter can continue to operate safely with the “healthy” cells. Defective battery cells can be switched off and bypassed and can therefore be safely replaced. The availability is thus significantly higher than in a direct series connection of the battery cells.

The described circuit essentially represents a combination of a multi-level inverter, active charge balancing and distributed battery management. It is also advantageous for safety that only one battery cell can be short-circuited in the event of a fault in the circuit. The fault current and the energy released as a result are significantly lower than in a conventional series circuit. In addition, only the voltage of a single battery cell is present after the inverter has been switched off. This simplifies the maintenance work considerably. Battery cells of different ages and types can be used in the same battery block. This increases the usable life of the battery.

In addition to the above-mentioned aspects, temperature is one of the biggest factors influencing the performance, durability and safety of batteries (particularly lithium-ion batteries). Therefore, the temperature of all battery cells should be kept within a certain tolerance range. Temperature problems in a battery pack can be divided into two groups: an overall increase in temperature due to energy lost during charging and discharging processes, and an uneven temperature distribution in the battery pack.

A general or global temperature increase of the battery can usually be sufficiently limited by effective cooling and power management.

Nevertheless, an uneven temperature distribution, in other words, temperature differences between the individual battery cells, cannot be avoided with the known techniques. The temperature differences within the battery lead to a reduction in the service life and performance of individual battery cells. Since in a battery system the service life, usable capacity and power are usually determined by the weakest battery cell, the performance, durability and safety of the entire battery pack is significantly reduced by the uneven temperature distribution. Therefore, it is desirable to ensure a uniform temperature distribution within the battery.

At present, very complex cooling systems are sometimes used to achieve this. Liquid cooling with controllable cooling channels is typically used.

### SUMMARY OF THE INVENTION

Taking account of the known prior art, the object of the present invention is to provide a method for generating an alternating voltage by interconnection of a plurality of DC voltage sources, which ensures particularly high performance, availability and safety.

A further object of the present invention is to provide an advantageous computer program for carrying out such a method.

Furthermore, an object of the invention is to provide a circuit assembly for generating an alternating voltage from a plurality of DC voltage sources, which ensures particularly high performance, availability and safety.

It is also an object of the invention to provide a power supply system based on a plurality of DC voltage sources, which ensures particularly high performance, availability and safety.

The object is achieved in relation to the method by the features specified in claim 1. With regard to the computer program, the object is achieved by the features of claim 10. Regarding the circuit assembly, the object is achieved by claim 10 and for the power supply system by claim 13.

The dependent claims and the features described below relate to advantageous embodiments and variants of the invention.

A method is provided for generating an alternating voltage by interconnection of a plurality of DC voltage sources.

The alternating voltage to be generated can preferably be a single-phase alternating voltage. However, provision may also be made for generating a multiphase alternating voltage, in particular a three-phase alternating voltage or three-phase current. Essentially, within the scope of the present invention multiple mutually independent alternating voltages and/or one or more DC voltages, in addition to at least one alternating voltage, can also be generated from the DC voltage sources if necessary. The at least one alternating voltage can be adjustable in amplitude, phase and/or frequency or can also be constant.

The DC voltage source may in particular be a single battery cell of a battery or a group (“battery module”) of multiple interconnected battery cells of a battery. The voltage source can also be, for example, a stand-alone battery or an assembly of multiple batteries.

A “battery” is understood in this context to mean both a rechargeable storage device (i.e. an “accumulator”/“battery pack”), the individual cells of which are also called “secondary cells”, as well as a non-rechargeable energy storage device. A battery or battery pack may in some cases also comprise a single battery cell. The present invention is therefore to be understood as being not necessarily limited to batteries with multiple interconnected battery cells. In addition, a battery in the present description can also mean a storage device for electrical energy that is not or not exclusively electrochemical in design, e.g. a capacitor.

Essentially, however, the DC voltage source can be any DC voltage source, thus, for example, also a DC voltage provided by an electronic module, for example, a DC voltage provided on the output side by a rectifier and/or a DC chopper. For simplification, the DC voltage sources are referred to below and above essentially as battery cells of a common battery, which is not limiting, however, but only to be understood as an example.

According to the invention, the following method steps are provided in the context of the method:
detecting charge differences of the DC voltage sources; and
taking the detected charge differences into account during the interconnection of the DC voltage sources to carry out charge balancing.

In the context of the invention, charge balancing is provided by manipulating the loading duration of the respective DC voltage sources during the generation of the AC voltage. This means that DC sources with higher residual charges are subjected to loading for longer than DC sources with lower residual charges. The length of time for which the DC voltage sources supply current is therefore preferably used as a control parameter for the charge balancing. For example, this method can be referred to as “Rotating balancing”. In principle, however, a passive charge balancing or an active charge balancing may also be provided in the context of the invention.

For detecting the charge differences, appropriate sensor units can be used, which detect, for example, voltages and/or currents of the individual DC voltage sources or a group of DC voltage sources.

Preferably, the interconnection of the DC voltage sources for generating the AC voltage is specified or modified with regard to the charge balancing.

According to the invention, the following method steps are additionally provided in the context of the method:
detecting temperature differences between the DC voltage sources; and
taking the detected temperature differences into account during the interconnection of the DC voltage sources to carry out a temperature equalization.

Preferably, the interconnection of the DC voltage sources for generating the AC voltage is specified or modified with regard to the temperature equalization.

The temperature sensors described in more detail below can be used to detect the temperature differences between the DC voltage sources. It should be mentioned at this point that it is not essential to the invention to assign a separate temperature sensor to each DC voltage source.

Because according to the invention temperature differences between the DC voltage sources are equalized, the performance, durability or availability and safety of the overall system can be significantly increased.

In addition to the equalization of the temperatures of the DC voltage sources, an additional cooling or other measure may optionally be provided to reduce the temperature of all DC voltage sources as a whole. For this purpose, cooling channels can be routed past the DC voltage sources, for example. Appropriate measures to reduce the temperature of a battery are known, so this will not be discussed in detail.

In an advantageous embodiment of the invention, it can be provided that the DC voltage sources are interconnected in a configurable series circuit in order to generate the alternating voltage, preferably by means of a staircase-shaped approximation.

The alternating voltage can be generated by summing the individual voltages of the individual DC voltage sources in a staircase pattern with small steps. The level of the lowest voltage level can correspond to the output voltage of the respective DC voltage source (e.g. the cell voltage of a battery cell, such as 3.7 V). In this way, the high clock frequencies of a pulse-width-modulated output voltage that are otherwise normally required, and the associated switching losses, can be greatly reduced.

The method according to the invention is particularly suitable in the context of a configurable series circuit, since the series circuit can be conveniently and flexibly adapted with regard to charge balancing and temperature equalization.

However, this does not exclude, for example, the possibility that in the context of the invention, DC voltage sources could also be optionally interconnected in a fixed wiring arrangement, for example in a series and/or parallel circuit. For example, battery modules can consist of two, three, four, five, six, seven, eight, nine, ten or even more permanently interconnected battery cells, which can then be interconnected in different configurations with further battery modules or battery cells. A fixed wiring arrangement of DC voltage sources or battery cells can be effected, for example, by means of busbars or other suitable electrical conductors.

According to a refinement of the invention, it can be provided that during the charge balancing, the charge removal from a charge-depleted DC voltage source is reduced and at least partially balanced by at least one other of the DC voltage sources.

A DC voltage source can be classified as a “charge-depleted DC source”, in particular if
a) a voltage difference of more than 5 mV is detected relative to the average DC voltage of all DC voltage sources, the largest DC voltage of all DC voltage sources, the smallest DC voltage of all DC voltage sources or at least one DC voltage of another of the DC voltage sources, in particular if the voltage difference or the magnitude of the voltage difference is more than 10 mV, more than 20 mV, more than 50 mV, more than 100 mV or more than 500 mV; or
b) a state of charge difference of more than 1% is detected relative to the average state of charge of all DC voltage sources, the largest DC voltage of all DC voltage sources, the smallest DC voltage of all DC voltage sources or at least one state of charge of another of the DC voltage sources, in particular if the state of charge difference is more than 2% or more than 3%.

For example, the state of charge difference or the state of charge can be calculated on the basis of a suitable battery model, e.g. on the basis of the battery cell voltage(s).

A state of charge difference threshold value can be specified which, when exceeded, causes the charge balancing of one or more DC voltage sources to be carried out. A particularly suitable threshold value can be, for example, 10 mV or 1%.

According to a refinement of the invention, it can be provided that only active power components of the DC voltage sources are taken into account and balanced among one another during the charge balancing process.

Since the reactive power component does not usually contribute in practice to a noticeable charge removal or charge supply from and into the DC voltage sources, the proposed charge balancing can be carried out particularly efficiently if the reactive power component is ignored during the charge balancing and the charge balancing is applied exclusively to the active power component. In principle, however, it is also possible to balance active power and reactive power components as part of the charge balancing process.

In a refinement of the invention it may be provided that temperature values detected by sensors and/or temperature values that are approximated and/or calculated by means of a suitable thermal model are used for detecting the temperature differences between the DC voltage sources.

Preferably, a combination of sensor-acquired temperature values and approximated or calculated temperature values is provided to determine the temperature differences.

The approximation or calculation of temperature values of DC voltage sources is particularly advantageous when multiple DC voltage sources are located close to one another, for example arranged next to one another in a common DC voltage module or battery module with a close packing density. In this way, the number of required temperature sensors can be reduced. For example, the temperature values of DC voltage sources arranged between or adjacent to DC voltage sources that are directly monitored by means of temperature sensors can be approximated by assuming a mean value between the temperatures of the adjacent DC voltage sources.

In a refinement of the invention it can be provided that currently detected temperature differences and/or expected future temperature differences, predicted based on a thermal model, can be taken into account during the temperature equalization process.

In some cases the thermal time constants of DC voltage sources in a temperature control system can be problematic, because they are usually in the range of a few tens of minutes to several hours and also have different sizes due to the different thermal conductivities of the individual DC voltage sources (e.g. battery cells or battery modules). Therefore, a predictive control of the temperature or predictive temperature equalization may be advantageous.

The time constants for each DC source or group of DC sources can be calculated using thermal models or determined during operation by taking measurements of the temperature and power characteristics of the individual DC voltage sources or groups.

Preferably, a combination of currently detected temperature differences and expected future temperature differences are taken into account.

According to a refinement of the invention, it can be provided that the charge removal from an overheated DC voltage source is reduced and at least partially balanced by at least one other of the DC voltage sources during the temperature equalization process.

A DC source can be classified as an “overheated DC voltage source” in particular if the temperature difference between its temperature and the average temperature of all DC voltage sources, the highest temperature of all DC voltage sources, the lowest temperature of all DC voltage sources, or at least a temperature of one of the DC voltage sources, exceeds a defined temperature threshold value.

In a refinement of the invention, it may be provided in particular that 1° C., 2° C., 5° C., 10° C., 15° C. or 20° C. is used as the temperature threshold value.

In particular, temperature differences from 10° C. to 15° C. between multiple battery cells of a battery are not uncommon in practice and are highly problematic during operation. A particularly suitable limit value or temperature threshold value can be 5° C., for example.

In an advantageous refinement of the invention, it can be provided that only reactive power components of the DC voltage sources are taken into account and balanced among one another during the temperature equalization process.

As already mentioned, the reactive power components of the DC voltage sources do not usually contribute in practice to a charge removal or charge supply from or into the DC voltage sources. However, due to losses, in particular resistive losses, the reactive power components nevertheless cause significant heating of the DC voltage sources. Therefore, the temperature equalization can be particularly effective if it specifically refers to the reactive power components.

Since both charge balancing and temperature equalization are provided in the context of the invention, a coordination of both equalization methods may be advantageous. In particular, a priority setting between charge and temperature equalization can be provided in order to avoid conflicts as far as possible. These priorities can be implemented by specifying the limits or threshold values for the charge and temperature differences of the individual DC voltage sources and by checking for limit violations.

Since the charge within a DC voltage source, such as a battery cell, is influenced substantially by the active power extracted or supplied and only slightly by the apparent power, whereas the apparent power certainly has a significant influence on the temperature of the DC voltage source, in particular, a separation of the two equalization methods into active power on the one hand (charge balancing) and apparent power on the other (temperature equalization) can provide sufficient scope for each of the two equalization methods. Conflicts between the two tasks can thus be avoided.

At this point it should be stressed that the method steps mentioned above and below do not necessarily have to be carried out in the order in which they are first described or mentioned in the description or in the claims. For example, individual method steps or groups of method steps can therefore be interchangeable where technically feasible. Method steps can also be combined with one another, divided into separate intermediate steps, or supplemented with intermediate steps. The method is also not necessarily described exhaustively with the listed method steps and can be supplemented with further method steps, including some not mentioned.

The invention also relates to a computer program comprising control commands which, during the execution of the program by a control device, cause said control device to carry out the method according to the comments above and below.

The control device can be implemented as a microprocessor. Instead of a microprocessor, any other device can also be provided for implementing the control device, for example, one or more arrangements of discrete electrical components on a printed circuit board, a programmable logic controller (PLC), an application-specific integrated circuit (ASIC) or another programmable circuit, for example, a field programmable gate array (FPGA), a programmable logic array (PLA) and/or a commercially available computer. The control device may also be produced from a combination of multiple electronic components distributed in a decentralized manner within the circuit assembly as described below.

The control device may also be a functional module of a higher-level control unit, for example, a functional module of a battery management system of the DC voltage sources, or a control unit of the power supply system (for example, of a vehicle) as described below.

The invention also relates to a circuit assembly for generating an alternating voltage from a plurality of DC voltage sources. The circuit assembly has an output-side interface for providing the generated AC voltage, and at least one inverter unit for generating and providing the AC voltage at the output-side interface from respective DC voltages of DC voltage sources that can be connected to the at least one inverter unit.

The at least one DC voltage source is preferably not to be regarded as a component of the circuit assembly.

The connection between the inverter units and the DC voltage sources can be effected, for example, via appropriate supply cables and/or busbars.

The circuit assembly, for example, the control modules to be described below, may if appropriate also be mechanically connectable to the DC voltage sources, for example, to a housing part of a DC voltage source or of multiple DC voltage sources (e.g. a housing part of a battery) in a positive-fitting, force-fitting and/or materially bonded manner.

One or more loads are or can be connected to the output-side interface of the inverter module. Said load is preferably not to be understood as a component of the circuit assembly. The load can be any electrical consumer up to and including a group of multiple electrical consumers. Preferably, the load is an electric motor, a drive unit and/or at least one electrical consumer within a low-voltage network (in particular a domestic power network).

According to the invention the circuit assembly also comprises a charge balancing unit for detecting and equalizing charge differences between the DC voltage sources, wherein the charge balancing unit is communicatively connected to the at least one inverter unit (e.g. to a control module of the inverter unit) in order to influence the interconnection of the DC voltage sources for the charge balancing process.

According to the invention the circuit assembly also comprises a temperature equalization unit for detecting and equalizing temperature differences between the DC voltage sources, wherein the temperature equalization unit is communicatively connected to the at least one inverter unit (e.g. to a control module of the inverter unit) in order to influence the interconnection of the DC voltage sources for the temperature equalization process.

A circuit assembly of an inverter can be advantageously provided, which provides thermal management for DC voltage sources of the inverter, in particular for battery cells of a battery.

It may be provided that the circuit assembly comprises the control device mentioned above or is communicatively connected to the control device. The charge balancing unit and/or the temperature equalization unit may be, for example, circuit-based or software-based components of the control device.

The control device may be configured to specify amplitudes, phases and/or frequencies on the output side for providing the AC voltage. The inverter or the inverter units can thus be flexibly configurable according to the specification of the control device, for example, to specify, control and/or regulate the operating behaviour of the electrical consumer.

It may be provided that the control device is communicatively connected to a control module of at least one of the DC voltage sources in order to receive status information regarding the DC voltage source(s) from the control module, wherein the control device may be further configured to take the status information into account during the configuration of the inverter for generating the AC voltage. This control module may be the same control module as used that of the respective inverter unit.

The control module can contain components of a battery management system of a battery or comprise a battery management system. A battery management system can be used to monitor and/or regulate the battery (sometimes referred to as a “power management system” (PMS)) and can transmit information in an analogue and/or digital form about the current status (for example, state of charge and/or temperature status) and/or design or characteristic parameters (e.g. nominal voltage, final charge voltage and/or identification data) of the respective battery and its battery cells. Therefore, the sensors already present in a battery can preferably be used for detecting the charge differences and/or temperature differences.

In an advantageous refinement of the invention, a cascade of more than one of the inverter units can be formed. Preferably, each of the inverter units is or can be connected to another of the DC voltage sources.

Inverters based on a cascade of multiple inverter units are also called “modular inverters”. In this technique, the individual DC voltage sources are not connected in series directly, but instead via the individual inverter units, for example the power-electronic H-bridges mentioned below.

Since the individual DC voltage sources can be switched in or out via a separate inverter unit, charge balancing between the DC voltage sources, i.e. between multiple battery cells, is possible. In the event of a failure of DC voltage sources, the inverter can also continue to be operated with the DC voltage sources that are still in working order. As a result, the availability of the power supply system can be much higher than with the conventional technique of a direct series connection of the DC voltage sources. Defective DC voltage sources, such as defective battery cells, can be switched off and bypassed. Not least, this also offers the possibility of safely replacing these DC voltage sources even during operation.

In an advantageous way, DC voltage sources of different ages or conditions and different types can be used in the same power supply system. This can significantly extend the useful life of a battery block, for example.

In an advantageous refinement of the invention, each of the inverter units has an H-bridge circuit consisting of four configurable power-electronic switching elements.

Such H-bridge circuits are generally known (see also “cascaded H-bridge”). For example, reference is made to DE 10 2018 003 642 A1 in this regard, the disclosed content of which is fully incorporated in this description by this reference. The invention is particularly suitable for use with inverters based on cascaded H-bridges. This is because it advantageously allows the interconnection of the DC voltage sources to be adjusted not only with regard to the charge balancing, but also with regard to the temperature equalization.

For example, any two of the aforementioned power-electronic switching elements can be connected at their outputs to form a series circuit and in each case to form a common connecting branch of the H-bridge circuit. Two such connecting branches can also be provided. In both connecting branches, one output of the inverter unit can be connected between the power-electronic switching elements. The respective ends of the connecting branches can be connected to each other, with an input of the inverter unit being connected to each end; the two connecting branches can thus be connected in parallel.

It may be provided that the configurable power-electronic switching elements are designed as bipolar transistors or preferably as MOSFETs. In principle, however, any switching elements, in particular semiconductor components, can be used. The configurable power-electronic switching elements can also be designed as relays. The design of the configurable power-electronic switching elements does not limit the invention in any way.

The power-electronic switching elements can be configured, for example, by the control device and/or the control module mentioned above. It may be provided that the control device is configured to optionally include individual DC voltage sources in the generation of the alternating voltage, or at least temporarily exclude them, depending on the status information transmitted by the control module to this DC voltage source.

The DC voltage sources can be temporarily excluded, in particular during the charge balancing or temperature equalization. However, provision may also be made to exclude faulty or overheated DC voltage sources in the long term. In particular, deeply discharged battery cells can also be excluded in the long term.

The invention also relates to a power supply system comprising a circuit assembly according to the comments above and below and the DC voltage sources, wherein the DC voltage sources are connected to the input-side interface of the circuit assembly.

A particularly advantageous application of the proposed power supply system relates to the electrical supply of electrical consumers of an electric vehicle, in particular an electric car.

According to a refinement, it can be provided that the power supply system has an energy storage module having the individual DC voltage sources. However, the DC voltage sources can also be independent of each other and do not necessarily have to be contained in a common energy storage module.

For example, the energy storage module may comprise a battery or be designed as a battery, wherein the individual DC voltage sources can be designed as battery cells of the battery.

The invention also relates to an electrical consumer arrangement, in particular an electric vehicle, comprising a power supply system according to the statements above and below, and at least one electrical consumer.

In principle, the electrical consumer arrangement can be any consumer arrangement which has at least one electrical consumer. For example, the consumer arrangement can include anything from an electrical power tool to a building to be supplied with electrical energy.

It may be provided that the electrical consumer has an electric motor, in particular an AC motor or a three-phase motor.

The electrical consumer arrangement is particularly preferably an electric vehicle. The term “electric vehicle” describes any electrically powered means of transport, in particular vehicles for land, water or air, including spacecraft. Preferably, however, the electric vehicle or the consumer arrangement chassis or bodywork is an electric car.

However, the invention is particularly suitable for the electrical supply of households or industrial plants.

Features which have been described in connection with one of the objects of the invention, in particular given by the circuit assembly, the power supply system, the consumer arrangement, the method and the computer program, can also be advantageously implemented for the other objects of the invention. Likewise, advantages mentioned in connection with one of the objects of the invention may also be understood to refer to the other objects of the invention.

In addition, it should be noted that terms such as “comprising” “having” or “with” do not exclude other features or steps. Furthermore, terms such as “a” or “the”, which refer to a singular number of steps or features, do not exclude a plurality of features or steps, and vice versa.

In a puristic embodiment of the invention, however, it may also be provided that the features in the invention introduced with the terms “comprising”, “having” or “with” are listed exhaustively. Accordingly, one or more enumerations of features within the scope of the invention may be considered as exhaustive, for example, as applying to each claim. For example, the invention may consist exclusively of the features specified in claim 1.

It should be mentioned that designations such as “first” or “second” etc. are primarily used for reasons of distinguishing between respective device or method features and are not necessarily intended to indicate that features are mutually dependent or related to each other.

At this point it should be noted that the terms “connected” or “connection” used in the present description and in the claims may describe a direct electrical connection of the components in question, but also an indirect electrical connection of said components (e.g. via further electrical conductors or electronic components such as resistors, inductors and/or capacitors, etc.). The term “joined”, on the other hand, usually indicates a direct connection of the mentioned components.

Furthermore, it should be stressed that the values and parameters described herein also include deviations or fluctuations of ±10% or less, preferably ±5% or less, more preferably ±1% or less, and particularly preferably ±0.1% or less of the respectively named value or parameter, provided that these deviations are not excluded in the practical implementation of the invention. The indication of ranges by way of starting and ending values also comprises all those values and fractions that are included in the respectively named range, in particular the starting and ending values and a respective mean value.

The invention also relates to a method independent of claim 1 for generating an alternating voltage by interconnecting a plurality of DC voltage sources, comprising at least the following method steps:
detecting temperature differences between the DC voltage sources; and
taking the detected temperature differences into account during the interconnection of the DC voltage sources to carry out a temperature equalization.

In particular, the charge balancing is preferably not part of the independent method. The applicant therefore explicitly reserves the right to claim the method even without charge balancing. This also applies to the computer program, the circuit assembly, the power supply system and the consumer arrangement. The other features of claim 1 and the dependent claims, as well as the features described in the present description, relate to advantageous embodiments and variants of these independent inventions.

### BRIEF DESCRIPTION OF THE DRAWINGS

In the following, exemplary embodiments of the invention are described in more detail based on the drawings.

The figures show preferred exemplary embodiments in each case, in which individual features of the present invention are shown in combination with one another. Features of an exemplary embodiment may also be implementable separately from the other features of the same exemplary embodiment and can accordingly be readily connected to features of other exemplary embodiments by a person skilled in the art to form further meaningful combinations and sub-combinations.

In the figures, functionally equivalent elements are provided with the same reference signs.

In the drawings, schematically in each case:

FIG. 1 shows a consumer arrangement consisting of an electrical consumer and a power supply system, according to an exemplary embodiment of the invention;

FIG. 2 shows an exemplary modular inverter of a circuit assembly according to the invention having multiple individually configurable inverter units;

FIG. 3 shows an H-bridge circuit of an exemplary inverter unit of a modular inverter of a circuit assembly according to the invention;

FIG. 4 shows a battery module with five battery cells connected in a series circuit; and

FIG. 5 shows a flow diagram of a method generating an alternating voltage according to an exemplary embodiment of the invention.

### DETAILED DESCRIPTION OF THE ENABLING EMBODIMENTS

FIG. 1 shows an electrical consumer arrangement 1, which may be, for example, an electric vehicle (in particular an electric car). The consumer assembly 1 has a power supply system 2 for electrically supplying an electrical consumer M. In the exemplary embodiment, the electrical consumer M is an electric motor, more precisely an AC or three-phase motor.

The power supply system 2 has a circuit assembly 3 and multiple DC voltage sources 4. The DC voltage sources 4 in the exemplary embodiment are part of a common energy storage module 5. The energy storage module 5 is preferably a battery or battery pack, wherein the individual DC voltage sources 4 are designed as battery cells or rechargeable battery cells of the battery or battery pack. In particular, the DC voltage sources 4 can be battery cells of a high-voltage energy storage device of an electric vehicle. The energy storage module 5 will sometimes be referred to hereafter as a battery and the DC voltage sources 4 as battery cells. However, this is only a preferred application and is not to be understood as limiting.

The energy storage module 5 or the battery may have one or preferably multiple control modules 6 to determine status information regarding the battery cells 4. The above-mentioned status information can in particular involve information about the current battery cell voltage U_{1 . . . n}, the current temperature T_{1 . . . n}, the current state of charge SoC_{1 . . . n}, or the current “state of health” of the respective battery cell 4.

The circuit assembly 3 proposed according to the invention, to which, among other things, the individual control modules 6 of the energy storage module 5 can be attributed, is used primarily for the electrical supply of the electrical consumer M that can be connected to the circuit assembly 3 by means of an alternating voltage u₁. The circuit assembly 3 also comprises a control device 8 (central controller) and multiple inverter units 9. In the exemplary embodiment, the control modules 6 are integrated into the respective inverter units 9—but this is only to be understood as one exemplary option.

For supplying the electrical consumer M, the circuit assembly 3 and/or the energy storage module 5 has an output-side interface 10 to which the generated alternating voltage u₁ is applied.

The inverter units 9 are configurable and the control device 8 is adapted to configure the inverter modules 9, in particular via their control modules 6, in order to adjust the alternating voltage u₁ of the electrical consumer M with regard to amplitude, phase and/or frequency optimally for its operation.

The control device 8 can be communicatively connected to the control modules 6 of the energy storage module 5 or the battery (in FIG. 1, for example, a communication bus 12 is indicated), in order to receive from the control modules 6 the previously mentioned status information relating to the individual battery cells 4 and to configure the same in a suitable manner for generating the alternating voltage u₁, taking into account the status information.

The control device 8, the control modules 6 and the inverter units 9 can be configured, in particular, to optionally include, or at least temporarily exclude, one of the DC voltage sources 4 or battery cells in the generation of the alternating voltage u₁ depending on the status information acquired by the control module 6 relating to this DC voltage source 4. In this way, in particular a charge balancing and a temperature equalization between the battery cells 4 can be carried out.

A computer program may be provided, comprising control commands which, during the execution of the program by the control device 8, cause said control device to carry out the method for generating the alternating voltage u₁ by suitable interconnection of the DC voltage sources 4 or battery cells.

The control device 8 comprises a charge balancing unit 13 for detecting and balancing charge differences between the DC voltage sources 4. In the exemplary embodiment of FIG. 1, the charge balancing unit 13 is shown as a black box within the control device 8 (e.g. implemented as a circuit module or software module), but this should only be understood as an example; the charge balancing unit 13 can also be implemented independently of the control device 8.

For the charge balancing, the charge balancing unit 13 is supplied with corresponding voltage differences □U, characteristic of the charge difference or the state of charge differences □SoC of the individual battery cells 4, and preferably with a voltage or charge difference threshold value S_{L}, which when exceeded for a respective battery cell 4 causes a charge balancing to take place. As part of the charge balancing, the charge removal from a charge-depleted DC voltage source can be reduced and at least partially balanced by at least one other of the DC voltage sources, if the DC voltage of the charge-depleted DC voltage source has a voltage difference □U, for example, of more than 5 mV relative to the average DC voltage of all DC voltage sources 4, in particular if the voltage difference □U amounts to more than 10 mV, more than 20 mV, more than 50 mV, more than 100 mV or more than 500 mV and/or if the state of charge SoC of the charge-depleted DC voltage source, for example, has a state of charge difference □SoC of more than 1% relative to the average state of charge of all DC voltage sources 4, in particular if the state of charge difference □SoC amounts to more than 2% or more than 3%.

The circuit assembly 3 also comprises a temperature equalization unit 14 for detecting and equalizing temperature differences □T between the DC voltage sources 4. In the exemplary embodiment of FIG. 1, the temperature equalization unit 14 is also shown as a black box within the control device 8 (e.g. implemented as a circuit module or software module), but again this should only be understood as an example. The temperature equalization unit 14 can therefore also be implemented independently of the control device 8.

For the temperature equalization, the temperature equalization unit 14 is supplied with corresponding temperature differences □T of the individual battery cells 4, and preferably with a temperature threshold value S_{T}, which when exceeded for a respective battery cell 4 causes a temperature equalization to take place. As part of the temperature equalization, the charge extraction from an overheated DC voltage source can be reduced and at least partially balanced by at least one other of the DC voltage sources if the temperature difference □T between the temperature of the overheated DC voltage source and the average temperature of all DC voltage sources 4 exceeds the temperature threshold value S_{T}. The temperature threshold value S_{T} used can be, for example, a temperature difference T of 1° C., 2° C., 5° C., 10° C., 15° C. or 20° C.

In particular, currently acquired temperature differences can be taken into account as part of the temperature equalization. Alternatively or as an addition, temperature differences □T to be expected in the future can also be predicted using a thermal model 15. This can be advantageous because the thermal time constant of a battery cell 4 is usually comparatively large.

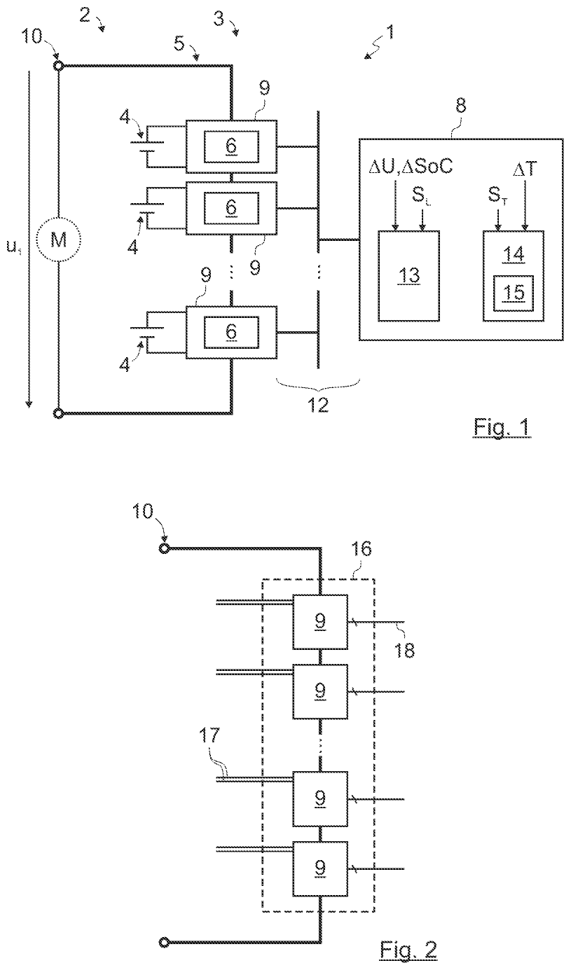

The design of the inverter units 9 can be essentially arbitrary. Preferably, however, the inverter units 9 together form a modular inverter 16, as illustrated in the example of FIG. 2.

The modular inverter 16 can therefore be designed as a cascade of the individual inverter units 9, wherein each of the inverter units 9 can be connected to another of the DC voltage sources 4. The corresponding supply cables 17, which can be connected to the battery cells or DC voltage sources 4, are also indicated in FIG. 2. Further, communication cables 18 are indicated, which can be connected to the control device 8 of the circuit assembly 3 (in particular via the communication bus 12). In this way, by appropriate configuration of the cascade, a stepwise or staircase-shaped alternating voltage u₁ can be generated from the individual DC voltage sources 4, as indicated in FIG. 5.

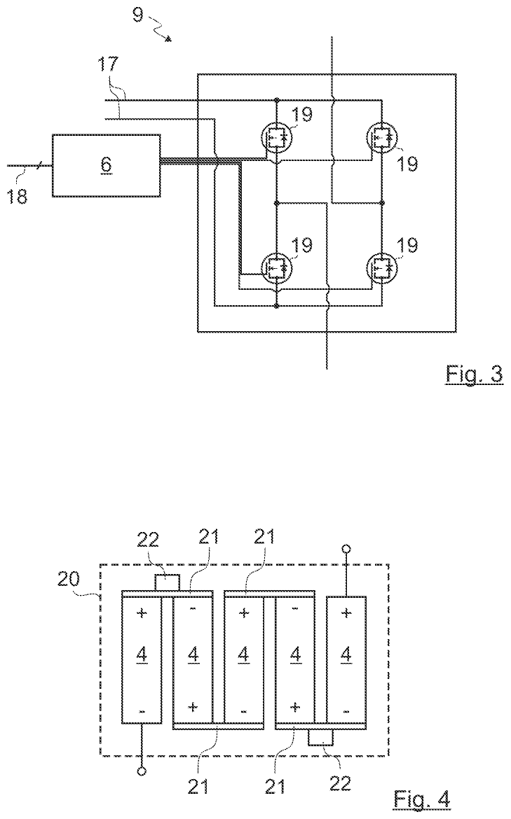

A possible structure of a single inverter unit 9 is shown in FIG. 3 as an example. The inverter units 9 can in particular each comprise an H-bridge circuit consisting of four power-electronic switching elements 19 configurable by the control device 8 and/or the control modules 6. The power-electronic switching elements 19 may be designed, for example, as semiconductor devices, in particular as MOSFETs indicated in FIG. 3. The control modules 6 can be designed to actuate the switching elements 19, optionally according to the specifications of the control device 8, which are transmitted to the respective control module 6 via the communication line 18 or communication bus 12.

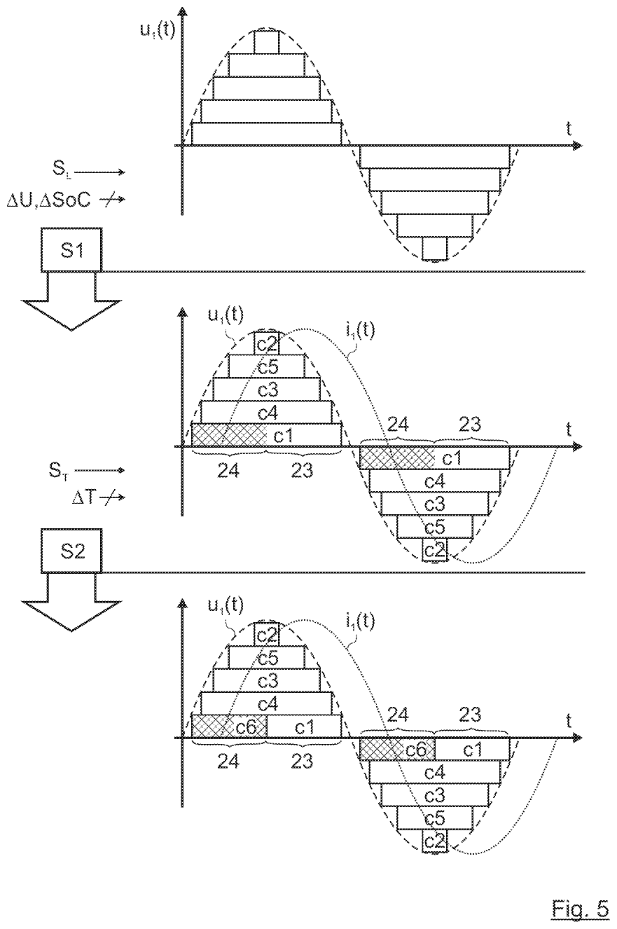

FIG. 4 shows an example of a battery module 20 of the energy storage module 5. On the one hand, this is intended to clarify that instead of individual battery cells 4, a group of battery cells 4 can also be used as a “DC voltage source” within the meaning of the present invention. In this respect, for example, five battery cells 4 are connected together in a hard-wired series circuit by means of busbars 21, in order to provide a common output voltage. Within the energy storage module 5, a plurality of such battery modules 20 can preferably be provided.

For detecting the temperature difference □T between the DC voltage sources 4, one or more temperature sensors 22 can be provided. In FIG. 4, two temperature sensors 22 are arranged, as an example, on the outer battery cells 4, which sensors are used to jointly detect the temperatures of the two battery cells 4 connected to the corresponding busbar 21. The temperature of the middle battery cell 4 can then preferably be approximated. In principle, however, any number of temperature sensors 22 can be provided within a battery module 20 or the battery or energy storage module 5 overall. The temperature sensors can be, for example, NTC or PTC sensors.

With reference to FIG. 5, an advantageous method sequence in the context of the invention will be illustrated as an example. In the context of the method according to the invention, it can be provided in particular to provide the alternating voltage u₁ by staircase-shaped approximation of the individual cell voltages of multiple battery cells. In FIG. 5, the principle is indicated by means of six exemplary battery cells c1-c6.

According to a first method step S1, a charge balancing between the individual battery cells c1 to c5 can be provided with the interconnection of the battery cells c1 to c5. For detecting the charge differences, voltage differences □U can be used or state of charge differences □SoC directly (for example, calculated with a model of the battery cells 4 from the respective battery cell voltages), and optionally a charge difference threshold value S_{L} can be used. On the basis of the residual charge or available capacities of the individual battery cells c1 to c5, the requirements for the staircase-shaped approximation of the AC voltage u₁ can be suitably distributed so that more charge is extracted from battery cells with a higher residual charge than from already charge-depleted battery cells. In FIG. 5, an exemplary distribution is indicated in the middle graph, in which the most charge is extracted from the lowest battery cell c1 and the least charge is taken from the topmost battery cell c2 (topmost position of the “staircase”). This distribution can preferably be regularly adjusted during operation. In particular, the construction of the alternating voltage u₁ may involve cycling through the battery cells c1 to c5 in such a way that charge differences between all battery cells c1 to c5 remain at a minimum.

For a charging operation, the construction of the AC voltage u₁ can be obtained in the reverse order of the discharge operation. This means that the battery cells 4 with the highest charge are assigned to the upper part of the sinusoidal curve and those with the lowest charge are assigned to the lower part of the sinusoidal curve.

In a second method step S2, it can be provided that, in addition to the charge balancing, a temperature equalization between the battery cells c1 to c5 is also carried out.

For this purpose, temperature differences □T detected between the battery cells c1 to c5 and preferably a temperature threshold value S_{T} are used. Provision can be made to protect already overheated DC voltage sources or battery cells as much as possible. Since this can lead to a contradiction with the parallel charge balancing task, it may be advantageous to balance only active power components 23 (e.g. for battery cell c1) of the battery cells c1 to c5 against each other during charge balancing and to balance only reactive power components 24 (e.g. for battery cell c1) during temperature equalization. The principle will be clarified using the middle and lower graphs in FIG. 5.

When reactive power is present, the current curve i(t) and voltage curve u(t) are known to be phase-shifted, as indicated in FIG. 5. Therefore, the generation of the AC voltage u₁ results in a cyclically oscillating charge component, i.e. a reactive power component, which essentially does not affect the actual charge extraction from the battery cells c1 to c5. The reactive power component 24 in the lowest battery cell c1 is shown cross-hatched in the middle graph of FIG. 5. Since this reactive power component 24 does not fundamentally affect the charge extraction from the battery cell c1, the charge balancing can preferably be limited to the active power component 23. On the other hand, due to short-circuit losses the reactive power component 24 also causes a temperature increase and thus a thermal load on the battery cell c1. In order to reduce the thermal load of the lowest battery cell c1, its reactive power component 24 can therefore be balanced by one or more other battery cells—in the exemplary embodiment, a sixth battery cell c6—, as indicated in the bottom graph of FIG. 5. The charge extraction from the first battery cell c1 and the sixth battery cell c6 essentially hardly changes at all, and the temperature equalization therefore has no or only a negligible effect on the charge balancing.

For temperature equalization and charge balancing it can be provided that a reserve of DC voltage sources 4 or battery cells (for example, the sixth battery cell c6) is available within the energy storage module 5 or battery. Alternatively or in addition, it may also be provided that the balancing is effected by one of the other battery cells 4 already used in the respective cycle. For example, the battery cells c2 to c5 can also be used for (partial) balancing, for example, of the reactive power component 24 of the first battery cell c1.

It is essential to mention that further method steps may also be provided. In particular, method steps can also be omitted within the context of the invention. In addition, the sequence of the method steps may vary.

What is claimed:

1. A method for generating an alternating voltage (u₁) by interconnecting a plurality of DC voltage sources, comprising at least the following method steps:
detecting charge differences of the DC voltage sources;
taking the detected charge differences into account during the interconnection of the DC voltage sources to carry out charge balancing; and
at least the following further method steps:
detecting temperature differences (□T) between the DC voltage sources; and
taking the detected temperature differences (□T) into account during the interconnection of the DC voltage sources to carry out temperature equalization, such that the detected temperature differences and the detected charge differences each may influence the interconnection of the DC voltage sources in order to provide a coordination of charge balancing and temperature equalization.

2. The method according to claim 1, wherein the DC voltage sources can be connected to one another in a configurable series circuit in order to generate the alternating voltage (u₁) by means of a staircase-shaped approximation.

3. The method according to claim 1, wherein during the charge balancing, the charge removal from a charge-depleted DC voltage source is reduced and at least partially balanced by at least one other of the DC voltage sources if:
a) the DC voltage (U_{1 . . . n}) of the charge-depleted DC voltage source has a voltage difference (□U) of more than 5 mV relative to the average DC voltage of all DC voltage sources (4), in particular if the voltage difference (□U) amounts to more than 10 mV, more than 20 mV, more than 50 mV, more than 100 mV or more than 500 mV; or
b) the state of charge (SoC) of the charge-depleted DC voltage source has a state of charge difference (□SoC) of more than 1% relative to the average state of charge of all DC voltage sources, in particular if the state of charge difference (□SoC) amounts to more than 2%.

4. The method according to claim 1, wherein essentially or only active power components of the DC voltage sources are taken into account and balanced with one another during the charge balancing.

5. The method according to claim 1, wherein to detect the temperature differences (□T) between the DC voltage sources, a combination of temperature values (T_{1 . . . n}) and approximate temperature values detected by sensors can be used.

6. The method according to claim 1, wherein currently detected temperature differences (□T) and expected future temperature differences, predicted based on a thermal model, can be taken into account during the temperature equalization.

7. The method according to claim 1, wherein during the temperature equalization, the charge removal from an overheated DC voltage source is reduced and at least partially balanced by at least one other of the DC voltage sources if the temperature difference (□T) between the temperature (T_{1 . . . n}) of the overheated DC voltage source and the average temperature of all DC voltage sources exceeds a defined temperature threshold value (S_{T}).

8. The method according to claim 7, wherein the temperature threshold (S_{T}) used is 1° C., 2° C., 5° C., 10° C., 15° C. or 20° C.

9. The method according to claim 1, wherein essentially or only reactive power components of the DC voltage sources are taken into account and balanced among one another during the temperature equalization.

10. A circuit assembly for generating an alternating voltage (u₁) from a plurality of DC voltage sources, comprising:
an output-side interface for providing the generated AC voltage (u₁);
at least one inverter unit for generating and providing the AC voltage (u₁) at the output-side interface from respective DC voltages (U_{1 . . . n}) of DC voltage sources that can be connected to the at least one inverter unit;
a charge balancing unit for detecting and balancing charge differences between the DC voltage sources, wherein the charge balancing unit is communicatively connected to the at least one inverter unit in order to influence the interconnection of the DC voltage sources for the charge balancing; and
a temperature equalization unit for detecting and equalizing temperature differences (□T) between the DC voltage sources, wherein the temperature equalization unit is communicatively connected to the at least one inverter unit in order to influence the interconnection of the DC voltage sources for the temperature equalization, such that the detected temperature differences and the detected charge differences each may influence the interconnection of the DC voltage sources in order to provide a coordination of charge balancing and temperature equalization.

11. The circuit assembly according to claim 10, wherein a cascade of more than one of the inverter units is formed, wherein each of the inverter units can be connected to another of the DC voltage sources.

12. The circuit assembly according to claim 11, wherein the inverter units each have an H-bridge circuit consisting of four configurable power-electronic switching elements.

13. A power supply system, comprising a circuit assembly according to claim 10 and the DC voltage sources, wherein the DC voltage sources are connected to the input-side interface of the circuit assembly.

14. The power supply assembly according to claim 13, further comprising an energy storage module comprising a battery, wherein the DC voltage sources are formed as battery cells of the battery.
